(19) United States
(12) Patent Application Publication
(10) Pub. No.: US 2010/0134775 A1
(43) Pub. Date: Jun. 3, 2010

(54) EXPOSURE APPARATUS AND DEVICE MANUFACTURING METHOD

(75) Inventor: Hajime Takeuchi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/624,722

(22) Filed: Nov. 24, 2009

(30) Foreign Application Priority Data
Nov. 28, 2008 (JP) 2008-303329

(51) Int. Cl. G03B 27/53; G03B 27/54

(52) U.S. Cl. 355/67

(57) ABSTRACT

An apparatus includes an original stage configured to hold an original, a substrate stage configured to hold a substrate, an illumination optical system configured to illuminate the original with light from a light source, a projection optical system configured to project light from the original to the substrate to expose the substrate, a detector configured to detect first light from a first reflecting member disposed on the original stage and second light from a second reflecting member disposed on the substrate stage produced by illumination with light, wherein either the first or second light travels forward and backward via the projection optical system, and is detected by the detector, and a processor configured to obtain intensities of the first and the second lights based on an output from the detector, and to calculate transmittance of the projection optical system based on the obtained intensities.

### BACKGROUND OF THE INVENTION

1. Field of the Invention

The present invention relates to an exposure apparatus and a device manufacturing method using the exposure apparatus.

2. Description of the Related Art

With an exposure apparatus, a contaminant adhering to an optical element or deterioration of a lens material decreases the transmittance of an optical system (for example, a projection optical system) used for exposure. Therefore, it is necessary to periodically measure the transmittance of the optical system, and replace and clean optical elements.

Conventional exposure apparatuses measure the light quantity by using a light quantity detecting unit disposed before and after an optical system along an optical path, and calculate the transmittance of the optical system from the ratio of the two light quantities. Japanese Patent Application Laid-Open No. 10-116766 and Japanese Patent Application Laid-Open No. 09-115802 discuss monitoring of the transmittance between an integrated-light quantity monitor disposed in an illumination optical system and an amount-of-exposure monitor disposed on a substrate stage. The transmittance is calculated based on the ratio of outputs of the two monitors.

The use of the two light quantity detecting units as discussed in the above-mentioned two patent applications may degrade the measurement accuracy since each unit separately deteriorates with time.

### SUMMARY OF THE INVENTION

The present invention provides, for example, an exposure apparatus that is advantageous for measurement of transmittance of an optical element, and a device manufacturing method using the exposure apparatus.

According to an aspect of the present invention, an exposure apparatus includes an original stage configured to hold an original, a substrate stage configured to hold a substrate, an illumination optical system configured to illuminate the original with light from a light source, a projection optical system configured to project light from the original illuminated by the illumination optical system to the substrate to expose the substrate to light, a detector configured to detect first reflected light from a first reflecting member disposed on the original stage and second reflected light from a second reflecting member disposed on the substrate stage produced by illumination with light from the light source, wherein either the first or second reflected light travels forward via the projection optical system and backward via the projection optical system, and is detected by the detector, and a processor configured to obtain intensities of the first reflected light and the second reflected light based on an output from the detector, and to calculate transmittance of the projection optical system based on the obtained intensities.

According to the present invention, for example, it is possible to provide an exposure apparatus advantageous for measurement of the transmittance of an optical element and a device manufacturing method using the same.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an exposure apparatus according to the present exemplary embodiment.

FIG. 2 is a detailed block diagram illustrating a Through The Reticle (TTR) microscope.

FIGS. 3A, 3B, and 3C are plan views of an original stage reference mark and a substrate stage reference mark, and FIG. 3D illustrates a signal waveform obtained therefrom.

FIG. 4 is a flow chart illustrating a flow of measurement.

FIGS. 5A and 5B are graphs for estimating a maintenance period.

### DESCRIPTION OF THE EMBODIMENTS

Various exemplary embodiments, features, and aspects of the invention will be described in detail below with reference to the drawings.

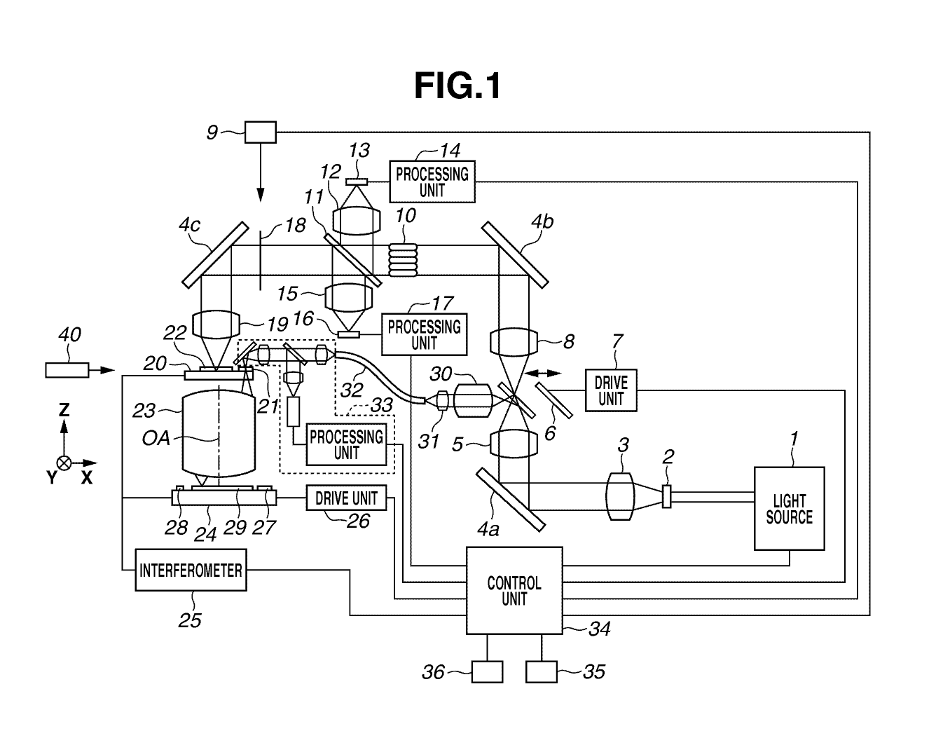

FIG. 1 is a block diagram illustrating an exposure apparatus according to the present invention. The exposure apparatus is a projection exposure apparatus, which projects a pattern formed on an original 22 (e.g., mask or reticle) onto a substrate 29 (e.g., wafer or liquid crystal substrate), and exposes the substrate 29 to light. Although the exposure apparatus according to the present exemplary embodiment employs the step and scan projection exposure method, the present exemplary embodiment is also applicable to exposure apparatuses employing the step and repeat projection exposure method.

The exposure apparatus according to the present exemplary embodiment includes a light source 1, an illumination optical system, an original stage 20, a projection optical system 23, a substrate stage 24, measurement systems, and a control unit 34. Referring to FIG. 1, the Z-axis direction is in parallel with the optical axis direction of the projection optical system 23, and the Y-axis direction coincides with the scanning direction. The X-axis direction perpendicularly intersects with both the optical axis direction and the scanning direction.

The light source 1 emits a light flux for illuminating an original 22 or a light flux used for exposure (exposure light). Although the light source 1 is an excimer laser in the present exemplary embodiment, the light source 1 may be a mercury lamp or an extreme ultraviolet (EUV) light generation unit. The control unit 34 of a control system controls the light source 1.

The illumination optical system is provided with a function to uniformly illuminate the original 22 by using the light flux from the light source 1, and includes a divergent lens 2, lenses 3, 5, and 8, folding mirrors 4a to 4c, a fly-eye lens 10, a masking blade 18, and a condenser lens 19.

The divergent lens 2 diverges the light flux from the light source 1 to an appropriate size. The lens 3 is a collimator lens for converting a light from the divergent lens 2 to a parallel light. The lens 5 is a condenser lens for condensing a light from the lens 3. The lens 8 is a collimator lens for converting a light from the lens 5 to a parallel light.

The fly-eye lens 10 is disposed between the folding mirrors 4b and 4c to form a secondary light source for uniformly illuminating the original 22. The fly-eye lens 10 can be replaced with another optical integrator such as an optical rod. An incidence plane and an exit plane of the fly-eye lens 10 have an optical relation of Fourier transform. The incidence plane is disposed at an optically conjugate position of the original 22.

Although the folding mirrors 4a to 4c deflect the light flux by a deflection angle of 90 degrees, the deflection angle is not limited thereto. The folding mirror 4a is disposed between the lens 3 and the lens 5. The folding mirror 4b is disposed between the lens 8 and the fly-eye lens 10. The folding mirror 4c is disposed between the masking blade 18 and the condenser lens 19.

The illumination optical system forms an exposure slit (an illumination area having a slit shape) on the original 22 by a slit member (not illustrated). The masking blade 18 is disposed at an optically conjugate position of the original 22 (between the folding mirror 4c and the half mirror 11, which is described below, in the present exemplary embodiment) to define an illumination area of the illumination light flux on the original 22. A drive unit 9 drives the masking blade 18. The condenser lens 19 forms an exposure slit on the original 22.

The original 22 having thereon a pattern to be transferred onto the substrate 29 is held to the original stage 20 via a holder (not illustrated). A drive unit (not illustrated) can move the original stage 20 having the original 22 thereon in the scanning direction (Y-axis direction) relative to the exposure slit.

The original stage 20 is provided with an original stage reference mark (alignment mark) 21 for positioning the original 22 with the substrate 29. The original stage reference mark 21 is disposed in anterior side of the projection optical system 23 along the exposure light path from the light source 1 to the substrate 29 to serve as a first reflecting member.

The original stage 20 serves as a first drive unit for driving the original stage reference mark 21 in a direction (X-axis or Y-axis direction) perpendicular to the optical axis OA of the projection optical system 23 to allow the original stage reference mark 21 to be placed into or removed from the optical path.

The projection optical system 23 projects a reduced image of the pattern formed on the original 22 onto the substrate 29, and provides an optically conjugate relation between the original 22 and the substrate 29. In the present exemplary embodiment, the projection optical system 23 is an optical system whose transmittance is to be measured. However, the optical system to be measure in the exposure apparatus may be any optical system used for projecting the pattern formed on the original 22 onto the substrate 29 by using the light flux from the light source 1, and is not limited to the projection optical system 23.

In the exemplary embodiments of the present invention, the transmittance means the ratio of the light to be used for measurement passing via the optical system to be measured. This does not mean that the optical system under measurement is composed only of light-transmitting optical elements such as refractive optical elements. Therefore, the projection optical system 23 (an optical system under measurement) may be a catadioptric system or a reflective optical system.

A gap between an optical element closest to the substrate 29 of the projection optical system 23 (final plane thereof) and the substrate 29 may be filled with a liquid having a higher refractive index than air to configure a so-called immersion exposure apparatus. Further, the projection optical system 23 is not limited to a reducing optical system, but may be a direct system or an expanding system.

The substrate 29 is held to the substrate stage 24 via a substrate holder (not illustrated). The drive unit 26 can drive the substrate stage 24 having the substrate 29 thereon in the X-, Y-, and Z-axis directions and in the rotational direction around each axis.

The substrate stage 24 is provided with a substrate stage reference mark (alignment mark) 27 for positioning the original 22 with the substrate 29. The substrate stage reference mark 27 is disposed in posterior side of the projection optical system 23 (an optical system to be measured) along the exposure light path from the light source 1 to the substrate 29 to serve as a second reflecting member.

The substrate stage 24 serves as a second drive unit for driving the substrate stage reference mark 27 in a direction (X- or Y-axis direction) perpendicular to the optical axis OA of the projection optical system 23 to allow the substrate stage reference mark 27 to be placed into or removed from the optical path.

The exposure apparatus includes four different measurement systems (first to fourth measurement systems). Each of the original stage 20 and the substrate stage 24 is provided with the first measurement system, which includes a bar mirror (not illustrated) and an interferometer 25. The bar mirror is disposed on each stage. The interferometer 25 irradiates a laser light onto the bar mirror and detects reflected light therefrom to measure the position of each stage.

A second measurement system includes a half mirror 11, a condenser lens 12, an integrated-light quantity monitor (a light quantity detecting unit) 13, a processing unit 14, and an amount-of-exposure monitor (an illuminance sensor) 28 to measure the amount of exposure.

A half mirror 11 is disposed between the fly-eye lens 10 and the folding mirror 4c (or between the fly-eye lens 10 and the masking blade 18) to lead a part of the light flux from the fly-eye lens 10 to the condenser lens 12 and the remainder thereof to the masking blade 18.

The condenser lens 12 condenses the light flux from the half mirror 11 onto the integrated-light quantity monitor 13.

The integrated-light quantity monitor 13 outputs a pulse current corresponding to the light quantity. The processing unit 14 converts the pulse current to a digital signal and then supplies the digital signal to the control unit 34. A target value to be compared with an integrated value output from the integrated-light quantity monitor 13 can be set by using measurement results of the amount-of-exposure monitor 28 for measuring the amount of exposure and a third measurement system.

First, the output value of the amount-of-exposure monitor 28 is associated with the absolute illuminance by using an external illuminometer 40 whose absolute sensitivity has been calibrated in advance. This association will be described in detail in a fourth exemplary embodiment described below.

Then, the output value of the amount-of-exposure monitor 28 is associated with the output value of the integrated-light quantity monitor 13. Then, the light quantity of reflected light is obtained from the substrate 29 under exposure by using the following third measurement system. Finally, a target value for the integrated-light quantity monitor 13 for obtaining a desired absolute illuminance on the substrate surface is determined.

The third measurement system measures reflected light (returned light) from the substrate 29 under exposure. The third measurement system includes a half mirror 11, a condenser lens 15, and a reflected-light monitor (a light quantity sensor) 16.

The half mirror 11 bends a part of reflected light from the folding mirror 4c by 90 degrees to lead the reflected light to the condenser lens 15. The half mirror 11 serves also as a deflecting member for deflecting reflected light from the original stage reference mark 21 or the substrate stage reference mark 27.

The condenser lens 15 condenses the reflected light from the folding mirror 4c onto the reflected-light monitor 16. The reflected-light monitor 16 is configured to receive the reflected light from the original stage reference mark 21 or the substrate stage reference mark 27 deflected by the half mirror 11 (deflecting member) and serves as a light quantity detecting unit, which outputs a pulse current according to the light quantity

The processing unit 17 converts the pulse current to a digital signal and then supplies the digital signal to the control unit 34. The reflected-light monitor 16 is disposed in anterior side of the original stage reference mark 21 along the exposure light path.

A fourth measurement system is a Through The Reticle (TTR) measurement system used to position the original 22 and the substrate 29. The TTR system images the original stage reference mark 21 provided on the original stage 20 and the substrate stage reference mark 27 provided on the substrate stage 24, and positions both marks via the projection optical system 23. The fourth measurement system includes a beam splitter, the original stage reference mark 21, the substrate stage reference mark 27, and a TTR microscope 33.

The beam splitter splits the light flux from the light source 1 and supplies the illumination light to the TTR microscope 33. The beam splitter includes a folding mirror 6, a drive unit 7, condenser lenses 30 and 31, and a fiber 32.

The drive unit 7 drives the folding mirror 6 to place and remove the folding mirror 6 into/from the optical path between the lenses 5 and 8. When the folding mirror 6 is disposed in the optical path of the illumination optical system, the optical path is changed. The condenser lenses 30 and 31 guide the illumination light from the folding mirror 6 to an incidence end of the fiber 32. The fiber 32 introduces the illumination light to the TTR microscope 33.

The TTR microscope 33 images the original stage reference mark 21 and the substrate stage reference mark 27 at the same time. The TTR microscope 33 is movable above the original stage 20 so that an image including both the original stage reference mark 21 and the substrate stage reference mark 27 can be captured via the projection optical system 23 with a plurality of image heights thereof.

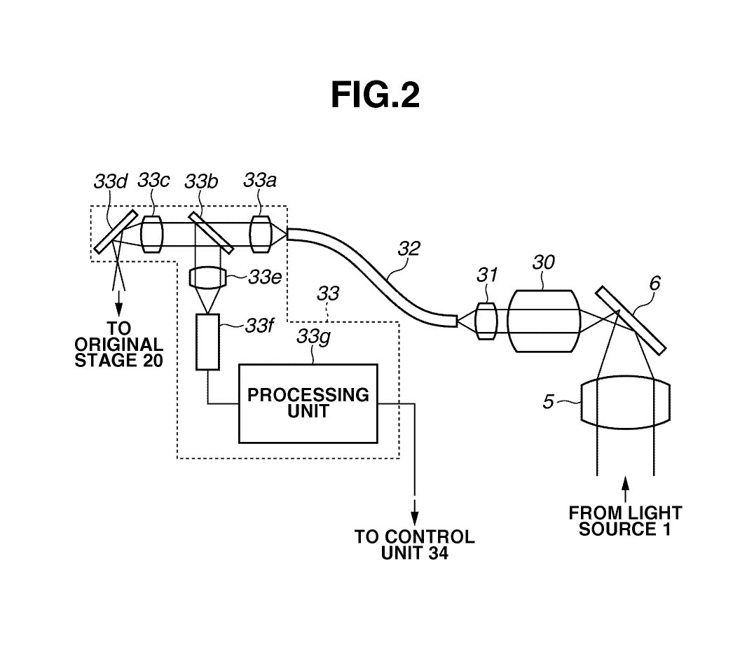

FIG. 2 is a detailed block diagram illustrating the TTR microscope 33. The TTR microscope 33 includes a collimator lens 33a, a half mirror 33b, condenser lenses 33c and 33e, a folding mirror 33d, a camera (a light quantity detecting unit) 33f, and a processing unit 33g.

The collimator lens 33a converts illumination light emitted from the exit end of the fiber 32 to a parallel light. The half mirror 33b transmits the light flux from the collimator lens 33a toward the folding mirror 33d, and reflects the light flux from the folding mirror 33d toward the condenser lens 33e.

The folding mirror 33d and the half mirror 33b serve as a deflecting member for deflecting the reflected light from the original stage reference mark 21 and the substrate stage reference mark 27. The camera 33f is configured to receive the reflected light from the original stage reference mark 21 and the substrate stage reference mark 27 deflected by the folding mirror 33d and the half mirror 33b. The camera 33f is disposed in anterior side of the original stage reference mark 21 along the optical path of the fourth measurement system.

The condenser lens 33c condenses the light flux from the collimator lens 33a onto the original stage reference mark 21 on the original stage 20. The original stage reference mark 21 includes reflective portions and a light-transmitting portion. The projection optical system 23 condenses the light that has penetrated the original stage reference mark 21 onto the substrate stage reference mark 27 on the substrate stage 24.

The reflected light from the reflective portion of the substrate stage reference mark 27 and the reflective portion of the original stage reference mark 21 forms an image of respective reflective portions on the camera 33f via the folding mirror 33d, the half mirror 33b, and condenser lens 33e. The processing unit 33g processes an image signal from the camera 33f and transmits the processed image signal to the control unit 34.

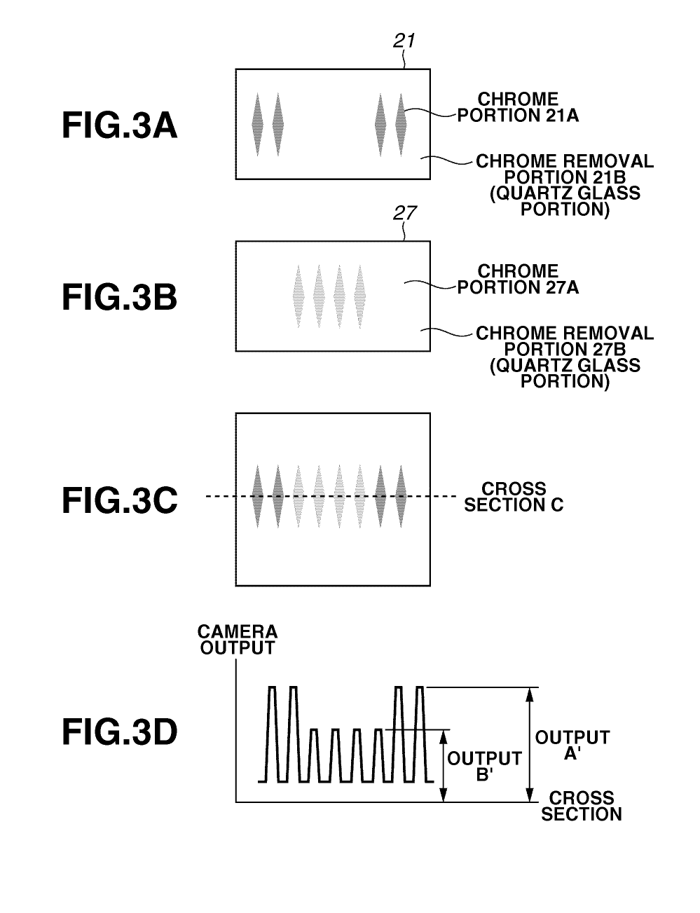

FIG. 3A is a plan view illustrating an example of the original stage reference mark 21. The original stage reference mark 21 includes chrome portions 21a (reflective portions), and a chrome removal portion (a quartz glass portion) 21b (i.e., light-transmitting portion). The chrome portions 21a are thin metal layers formed on the quartz glass portion 21b using vacuum evaporation.

FIG. 3B is a plan view illustrating an example of the substrate stage reference mark 27. The substrate stage reference mark 27 includes chrome portions 27a (i.e., reflective portions), and a chrome removal portion (a quartz glass portion) 27b (i.e., light-transmitting portion). The chrome portions 27a are thin metal layers formed on the quartz glass portion 27b using vacuum evaporation.

FIG. 3C illustrates an image of the original stage reference mark 21 and the substrate stage reference mark 27 captured by the camera 33f. As illustrated in FIG. 3C, the fourth measurement system performs alignment so that the substrate stage reference mark 27 is disposed inside the original stage reference mark 21.

The original stage reference mark 21 and the substrate stage reference mark 27 can be imaged with different image heights of the projection optical system 23 by controlling a drive unit (not illustrated) to drive at least apart of elements in the TTR microscope 33.

The control unit 34 controls each portion of the exposure apparatus.

In alignment, the control unit 34 controls the drive unit 7 to place the mirror 6 into the optical path of the illumination optical system, and calculates the amount of positional deviation of each reference mark based on information from the processing unit 33g. Then, the control unit 34 controls the original stage 20 and the substrate stage 24 so that the amount of positional deviation becomes zero, that is, the state illustrated in FIG. 3C is achieved.

At the time of exposure, the control unit 34 controls the drive unit 7 to remove the folding mirror 6 from the optical path of the illumination optical system. The control unit 34 receives an output from the interferometer 25, monitors positions of the original stage 20 and the substrate stage 24, and transmits a control signal to the drive unit of the original stage 20 and the drive unit 26 to control the positions of both stages.

Further, the control unit 34 controls the light source 1 to emit a light in synchronization with the drive of the original stage 20 and the substrate stage 24. Thereby, the pattern on the original 22 is transferred onto the substrate 29. The control unit 34 controls the drive unit 9 to limit the angle of view by the masking blade 18 to illuminate only a pattern area on the original 22 to be transferred onto the substrate 29. An area on the original plate illuminated by the illumination optical system is referred to as angle of view.

In amount-of-exposure control, the control unit 34 controls the voltage or current value applied to the light source 1 while referencing the output value from the processing units 14 and 17 to control the light quantity of the light source 1. Simultaneously, the control unit 34 appropriately sets conditions including the oscillating frequency of the light source 1, the light attenuation ratio of the illumination optical system, and the scanning speed of the original stage 20, and performs exposure operations to control the amount of exposure on the substrate surface.

As described below referring to each exemplary embodiment, the control unit 34 performs the following control operations when measuring the transmittance of the projection optical system 23. The control unit 34 controls positions on the original stage 20 and the substrate stage 24 so that a single light quantity detecting unit can detect the light quantity of reflected light reflected from the original stage reference mark 21 to the light source side, and the light quantity of reflected light from the substrate stage reference mark 27 to the light source side.

Since the single light quantity detecting unit detects the light quantity of two different reflected light fluxes, it is possible to perform measurement more exactly than a case where two different light quantity detecting units are used as discussed in Japanese Patent Application Laid-Open No. 10-116766 and Japanese Patent Application Laid-Open No. 09-115802. This is because, when two different light quantity detecting units are used, they separately deteriorate with time.

In an exemplary embodiment, the control unit 34 controls the original stage 20 and the substrate stage 24 to separately perform measurement of the light quantity of the reflected light from the original stage reference mark 21 (first light quantity measurement) and measurement of the light quantity of the reflected light from the substrate stage reference mark 27 (second light quantity measurement), respectively.

In the first light quantity measurement, the control unit 34 controls the original stage 20 to place the original stage reference mark 21 into the optical path. As a result, the control unit 34 can control the light quantity detecting unit to detect the light quantity (a first light quantity) of the reflected light flux reflected to the light source side by the original stage reference mark 21. At this time, the substrate stage 24 may be positioned anywhere.

In the second light quantity measurement, the control unit 34 controls the original stage 20 to remove the original stage reference mark 21 from the optical path. The control unit 34 also controls the substrate stage 24 to place the substrate stage reference mark 27 into the optical path.

As a result, the control unit 34 can control the single light quantity detecting unit to detect the light quantity (a second light quantity) of the reflected light flux to the light source side by the substrate stage reference mark 27.

In another exemplary embodiment, the control unit 34 performs the first and second light quantity measurements at the same time or in parallel. That is, the control unit 34 controls the original stage 20 to place the original stage reference mark 21 into the optical path and, at the same time, controls the substrate stage 24 to place the substrate stage reference mark 27 into the optical path.

Then, the control unit 34 controls the light quantity detecting unit to detect the light quantity of the reflected light from the original stage reference mark 21 and the light quantity of the reflected light from the substrate stage reference mark 27 at the same time or in parallel.

The deflecting members reflect the reflected lights and then lead them to the light quantity detecting unit. Therefore, it is not necessary to dispose the light quantity detecting unit on the optical path. This does not prevent downsizing of the exposure apparatus.

The control unit 34 notifies an operator of the fact that the transmittance of the projection optical system 23 has fallen below a threshold value or of an estimated time period at which the transmittance falls therebelow.

A memory unit 35 and an alarming unit 36 are connected to the control unit 34. The memory unit 35 stores a transmittance threshold value Tth described below. The alarming unit 36 includes a display unit for notifying the operator of the fact that the transmittance T of the projection optical system 23 has fallen below the transmittance threshold value Tth, and an output unit having a lamp or a speaker.

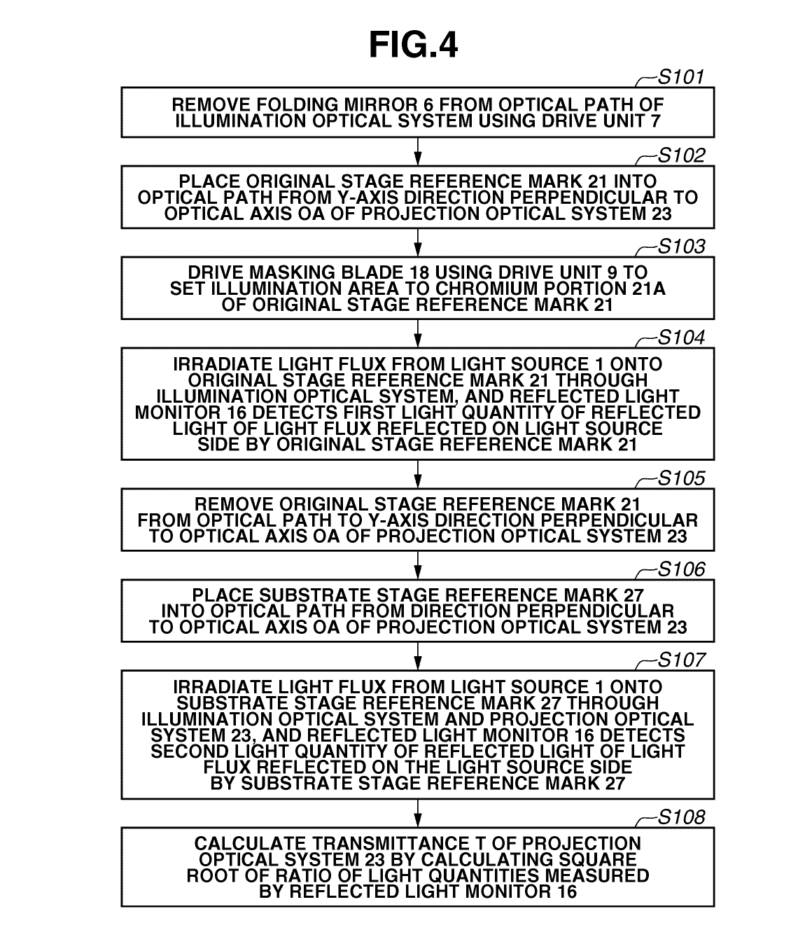

A method for measuring the transmittance of the projection optical system 23 according to a first exemplary embodiment will be described with reference to FIGS. 1 and 4. FIG. 4 is a flow chart of the measurement method.

In step S101, the control unit 34 controls the drive unit 7 to remove the folding mirror 6 from the optical path of the illumination optical system.

In step S102, the control unit 34 controls a drive unit (not illustrated) to drive the original stage 20 to place the original stage reference mark 21 into the optical path from the Y-axis direction perpendicular to the optical axis OA of the projection optical system 23 (i.e., to move the original stage reference mark 21 to the inside of an illumination area of the illumination optical system). Moving the original stage reference mark 21 in the Y-axis direction perpendicular to the optical axis OA of the projection optical system 23 can reduce a space occupied by the original stage reference mark 21. This does not prevent downsizing of the exposure apparatus.

In step S103, the control unit 34 controls the drive unit 9 to drive the masking blade 18 to set the illumination area to the chrome portions 21a on the original stage reference mark (a first reflecting member or a first reference mark) 21.

In this state, in step S104, the control unit 34 irradiates the light flux from the light source 1 onto the original stage reference mark 21 via the illumination optical system. A part of the illumination light reflects off the chrome portions 21a on the original stage reference mark 21 (with a reflectivity Ra) and returns to the light source side. The half mirror 11 splits the reflected light and leads a part thereof to the reflected-light monitor (light quantity sensor) 16.

As a result, the control unit 34 controls the reflected-light monitor 16 to detect a reflected light flux (the first light quantity) reflected to the light source side by the original stage reference mark 21 to obtain an output according to the amount of the reflected light from the original stage reference mark 21. The first light quantity (or an output value of the reflected-light monitor 16 or first reflected light) measured by the reflected-light monitor 16 is referred to as a first light quantity A.

In step S105, the control unit 34 controls a drive unit (not illustrated) to drive the original stage 20 in a direction (Y-axis direction) perpendicular to the optical axis OA of the projection optical system 23 to remove the original stage reference mark 21 from the optical path (i.e., to move the original stage reference mark 21 to the outside of the illumination area) to directly illuminate the projection optical system 23.

In step S106, the control unit 34 also controls the drive unit 26 to drive the substrate stage 24 to place the chrome portions 27a on the substrate stage reference mark 27 into the optical path from a direction (X- or Y-axis direction) perpendicular to the optical axis OA of the projection optical system 23 (i.e., to move the chrome portions 27a to the inside of the illumination area). Moving the substrate stage reference mark 27 in a direction perpendicular to the optical axis OA of the projection optical system 23 can reduce the space occupied by the substrate stage reference mark 27. This does not prevent downsizing of the exposure apparatus.

In this state, in step S107, the control unit 34 radiates the light flux from the light source 1 onto the substrate stage reference mark 27 (a second reflecting member or a second reference mark) through the illumination optical system and the projection optical system 23. A part of the illumination light reflects on the chrome portions 27a on the substrate stage reference mark 27 (with a reflectivity Rb) and returns to the light source side. The reflected light passes through the projection optical system 23. Then, the half mirror 11 in the illumination optical system splits the reflected light and leads a part thereof to the reflected-light monitor 16.

As a result, the control unit 34 controls the reflected-light monitor 16 to detect a reflected light flux (the second light quantity) reflected to the light source side by the substrate stage reference mark 27 to obtain an output according to the amount of the reflected light from the substrate stage reference mark 27. The second light quantity (or an output value of the reflected-light monitor 16 or second reflected light) measured by the reflected-light monitor 16 is referred to as a second light quantity B.

The first light quantity A and the second light quantity B can be represented by formulas (1) and (2), respectively.

A=X×P×Ra×T′×Rh (1)

B=X×P×T×Rb×T×T′×Rh (2)

where P denotes the illumination light intensity on the original plate, T′ denotes the transmittance from the original surface to the half mirror 11, Rh denotes the reflectivity of the half mirror 11, X denotes the conversion efficiency of the reflected-light monitor 16, and T denotes the transmittance of the projection optical system 23.

From formulas (1) and (2), the transmittance T of the projection optical system 23 is represented by formula (3).

T=√{(B/Rb)/(A/Ra)} (3)

Since the original stage reference mark 21 and the substrate stage reference mark 27 are thin metal layers formed on the quartz glass substrate using vacuum evaporation, the reflectivity of each mark to the illumination light can be considered to be identical. Therefore, in step S108, the control unit 34 can obtain the transmittance T of the projection optical system 23 by calculating the square root of the ratio of the second light quantity B to the first light quantity A measured by the reflected-light monitor 16, as illustrated by formula (4).

T=√(B/A) (4)

If the transmittance T of the projection optical system 23 decreases by an effect of degraded lens material and contamination (adhesion of contaminant), the light quantity that can reach the substrate 29 decreases, resulting in a decrease in productivity. To prevent this, the control unit 34 periodically measures the transmittance T of the projection optical system 23 with the above-described method, and notifies the operator of the necessity to perform maintenance when the transmittance falls below the threshold value Tth stored in the memory unit 35 via the alarming unit 36.

Maintenance includes replacement and cleaning of optical elements. The projection optical system 23 includes a plurality of optical elements. Contamination occurs frequently on the surface of an optical element closest to the original 22 and on the surface of an optical element closest to the substrate 29, both surfaces being in contact with the atmosphere in the exposure apparatus. After cleaning or replacement of optical elements, the effect of maintenance can be validated by measuring the transmittance of the projection optical system 23 with a similar method.

The control unit 34 may monitor the light source output using the integrated-light quantity monitor 13 during measurement of the amount of the reflected light or illuminance, and control the light source 1 to reduce measurement error caused by variation in light source output.

Reflecting members may not be limited to the original stage reference mark 21 and the substrate stage reference mark 27, but may be other members (for example, a semiconductor wafer as the substrate 29 or other reflecting members). When using other reflecting members, the reflecting member on the original stage 20 and the reflecting member on the substrate stage 24 are made of the same material. When using different materials, materials having a known reflectivity are used.

When using the substrate 29, for example, it is also possible to mount the substrate 29 alternately onto the original stage 20 and the substrate stage 24 in reflected-light measurement. Thus, an influence by the difference in reflectivity can be eliminated and the measurement accuracy is improved. Reflecting members may be spherical mirrors. Further, it is also possible to mount another reflecting member different from the substrate 29 alternately onto the original stage 20 and the substrate stage 24 (to dispose the reflecting member selectively in the optical path) and then sequentially detect reflected light.

The transmittance can be measured at a desired position within the angle of view by appropriately setting positions of the original stage 20, the substrate stage 24, and the masking blade 18. Therefore, a transmittance distribution in the angle of view can be used instead of the transmittance T. Both the transmittance and the transmittance distribution may be used as a criterion for determining maintenance. The concept of transmittance in the present invention includes the transmittance distribution.

The exposure apparatus is provided with a plurality of illumination conditions suitable for the original plate pattern. For example, the illumination shape can be changed between circular illumination, annular illumination, and quadrupolar illumination by changing the aperture shape of an aperture stop (not illustrated) disposed in the vicinity of the exit plane of the fly-eye lens 10. Since the position in the projection optical system 23 at which the light flux passes depends on illumination conditions, it is also possible to measure the transmittance for each illumination condition and use it as a criterion for determining maintenance.

It is also possible to place a reflecting member at a desired position in posterior side of the reflected-light monitor 16 to allow measurement of the transmittance between the reflecting members. It is desirable to place a reflecting material at the focal plane or in the vicinity of the pupil plane.

For example, when the condenser lens 19 (an optical system) is a target to be measured, a reflecting member can be placed between the half mirror 11 and the condenser lens 19, and the original stage reference mark 21 can be used as another reflecting member. In other words, the condenser lens 19 exists between the two reflecting members as an optical system to be measured.

The present exemplary embodiment utilizes the reflected-light monitor 16 originally installed in the exposure apparatus. Therefore, it is not necessary to add a measuring instrument such as an external illuminometer to the exposure apparatus in order to measure the transmittance of the optical system under measurement.

The present exemplary embodiment also utilizes the original stage reference mark 21 and the substrate stage reference mark 27 originally installed in the exposure apparatus as reflecting members. Placing and removing a thin reflecting member in a direction perpendicular to the optical axis OA make it possible to measure the transmittance at a desired optical system portion (one or a plurality of optical elements) disposed in the posterior side of the reflected-light monitor 16.

In the present exemplary embodiment, since the transmittance is measured by a reflected-light monitor 16, measurement is not affected by change in sensitivity of each individual measuring instrument unlike cases discussed in Japanese Patent Application Laid-Open No. 10-116766 and Japanese Patent Application Laid-Open No. 09-115802 in which two measuring instruments are used. The transmittance of an optical system depends on the wavelength. In the present exemplary embodiment, since the transmittance of the optical system to be measured is measured by actual exposure light, the transmittance of the projection optical system 23 can be accurately measured, and accordingly correct timing of maintenance can be known.

When illuminating the original 22 by the light flux from the light source 1 and exposing the substrate 29 to the pattern on the original 22 via the projection optical system 23, the transmittance of the projection optical system 23 larger than the threshold value is secured. Therefore, the exposure apparatus according to the present exemplary embodiment is advantageous, for example, in terms of device productivity.

A method for measuring the transmittance of the projection optical system 23 according to a second exemplary embodiment will be described below with reference to FIGS. 1 and 2.

First, the control unit 34 controls the drive unit 7 to place the folding mirror 6 into the optical path of the illumination optical system. Subsequently, the control unit 34 controls a drive unit (not illustrated) to drive the original stage 20 to move the original stage reference mark 21 to an imageable area of the TTR microscope 33.

The control unit 34 also controls a drive unit (not illustrated) to set the imageable area of the TTR microscope 33 to the chrome portions 21a on the original stage reference mark 21. In this state, the control unit 34 irradiates the light flux from the light source 1 onto the original stage reference mark 21 via the beam splitter and the TTR microscope 33. Then, a part of the illumination light reflects off the chrome portions 21a on the original stage reference mark 21 (with a reflectivity Ra) and then returns to the light source side.

The half mirror 33b splits this reflected light and leads a part thereof to the camera 33f. Therefore, the camera 33f can image the original stage reference mark 21 according to the amount of the reflected light. The control unit 34 obtains an output level A of the camera 33f.

Then, the control unit 34 controls a drive unit (not illustrated) to drive the original stage 20 to move the original stage reference mark 21 to the outside of the illumination area to directly illuminate the projection optical system 23 via the TTR microscope 33. The control unit 34 also controls the drive unit 26 to drive the substrate stage 24 to move the chrome portions 27a on the substrate stage reference mark 27 to the imageable area of the TTR microscope 33.

In this state, the control unit 34 irradiates the light flux from the light source 1 onto the substrate stage reference mark 27 via the beam splitter, the TTR microscope 33, and the projection optical system 23. Then, a part of the illumination light reflects off the chrome portions 27a on the substrate stage reference mark 27 (with a reflectivity Rb), and then returns to the light source side.

The reflected light passes through the projection optical system 23. The half mirror 33b in the TTR microscope 33 splits the reflected light and leads a part thereof to the camera 33f. Therefore, the camera 33f can image the substrate stage reference mark 27 according to the amount of the reflected light. The control unit 34 obtains an output level B of the camera 33f.

The output levels A and B of the camera 33f and the transmittance T of the projection optical system 23 can be represented similarly to formulas (1) to (4) described above, where P denotes the illumination light intensity of the TTR microscope 33 on the original surface, T′ denotes the transmittance from the original surface to the half mirror 33b, Rh denotes the reflectivity of the half mirror 33b, X denotes the conversion efficiency of the camera 33f, and T denotes the transmittance of the projection optical system 23.

The present exemplary embodiment maintains optical elements by using the transmittance T of the projection optical system 23 measured by the above-described method in similar way to the first exemplary embodiment. Similar to the first exemplary embodiment, the present exemplary embodiment can use the substrate 29 and the spherical mirror as reflecting members and measure the transmittance distribution within a driving range of the TTR microscope 33. Similar to the first exemplary embodiment, by placing a reflecting member at a desired position in the posterior side of the camera 33f, the present exemplary embodiment can measure the transmittance at an optical system portion according to the position.

Although the TTR microscope 33 according to the present exemplary embodiment images the chrome portions 21a and 27a, the imaging area can include the chrome removal area. For example, the camera 33f may capture a reflected mark image (see FIG. 3A) from the original stage reference mark 21 and a reflected mark image (see FIG. 3B) from the substrate stage reference mark 27 at the same time.

In this case, the outputs A and B may be replaced with the outputs A′ and B′ illustrated in FIG. 3D. FIG. 3D is a graph of the camera output illustrating the distribution of the amount of the reflected light taken along the cross section (dashed line) C of FIG. 3C.

The present exemplary embodiment utilizes the TTR microscope 33 originally installed in the exposure apparatus. Therefore, it is not necessary to add a measuring instrument such as an external illuminometer to the exposure apparatus in order to measure the transmittance of the optical system to be measured. The present exemplary embodiment also utilizes the original stage reference mark 21 and the substrate stage reference mark 27 originally installed in the exposure apparatus as reflecting members.

Placing and removing these thin reflecting members in a direction perpendicular to the optical axis make it possible to measure the transmittance at a desired optical system portion in the posterior side of the camera 33f. In the present exemplary embodiment, since the transmittance is measured by a single camera 33f, measurement is not affected by change in sensitivity of each individual measuring instrument unlike cases discussed in Japanese Patent Application Laid-Open No. 10-116766 and Japanese Patent Application Laid-Open No. 09-115802 in which two measuring instruments are used.

Similar to the first exemplary embodiment, the present exemplary embodiment makes it possible to know correct timing of maintenance by accurately measuring the transmittance of the projection optical system 23, and is advantageous in terms of device productivity.

A third exemplary embodiment, a modification of the first exemplary embodiment, will be described below. The present exemplary embodiment measures the amount of the reflected light A from the original stage reference mark 21 and the amount of the reflected light B from the substrate stage reference mark 27 by using the reflected-light monitor 16 in similar way to the first exemplary embodiment.

In the first exemplary embodiment, the reflectivity of the original stage reference mark 21 (Ra) and the reflectivity of the substrate stage reference mark 27 (Rb) are equal to each other (Ra=Rb) in formula (3). However, since the incidence angle distribution of the illumination light reaching the reference marks depends on NA (numeric aperture) of the optical system, the reflectivity Ra and reflectivity Rb are not identical.

Then, the following formula (5) is given.

B=NA1/NA2 (5)

where β is the magnification of the illumination optical system, NA1 is NA (on the original surface) of the illumination optical system, and NA2 is NA (on the substrate surface) of the projection optical system 23.

The reflectivity Ra and reflectivity Rb at the chrome portions on the reference marks are obtained in advance through an experiment or calculation based on NA1 and NA2, which are illumination conditions used for transmittance measurement for the projection optical system 23. From the obtained reflectivity Ra and reflectivity Rb, the transmittance of the projection optical system 23 can be accurately measured by using formula (3).

The difference between Ra and Rb becomes more remarkable with larger NA. Therefore, when measuring the transmittance under illumination conditions including large NA, for example, in the case of an immersion exposure apparatus, it is effective to apply the method according to the present exemplary embodiment.

The present exemplary embodiment maintains optical elements by using the transmittance T of the projection optical system 23 measured by the above-mentioned method in similar way to the first exemplary embodiment. Similar to the first exemplary embodiment, the present exemplary embodiment can use the substrate 29 and the spherical mirror as reflecting members and measure the transmittance distribution in the angle of view under a plurality of illumination conditions.

Similar to the first exemplary embodiment, by placing a reflecting member at a desired position in the posterior side of the reflected-light monitor 16, the present exemplary embodiment can measure the transmittance at an optical system portion according to the position.

Similar to the second exemplary embodiment, the present exemplary embodiment may measure the transmittance by using the camera 33f of the TTR microscope 33 instead of the reflected-light monitor 16. In this case, at least a relation between NA (NA2) of the projection optical system 23 and the reflectivity Rb may be obtained since the illumination light coming from other than the illumination optical system is used.

Other units for detecting reflected light may be any photo detector (photoelectric conversion element such as a CCD, a photo-diode, and a photomultiplier, and thermoelectric element such as a thermocouple and a pyroelectric sensor) preinstalled in the optical path.

Although the present exemplary embodiment has been described referring to the difference in reflectivity by the difference in NA (optical incidence angle to the reflecting member) of the illumination optical system and the projection optical system 23, a similar method can be applied to the difference in reflectivity caused by the difference in material and surface shape of reflecting members. The present exemplary embodiment can provide an effect of an increase in measurement accuracy in addition to the effect of the first exemplary embodiment.

A method for associating the output value of the amount-of-exposure monitor (the illuminance sensor) 28 for measuring the amount of exposure with the absolute illuminance will be described below. Measurement accuracy deterioration with time can be prevented by enabling the performance of the amount-of-exposure monitor 28 to be confirmed after installation of the exposure apparatus.

First, the control unit 34 measures the transmittance T of the projection optical system 23 by using the reflected-light monitor 16 using the method described in the first or third exemplary embodiment. Thus, the control unit 34 obtains the transmittance T of the projection optical system 23.

Subsequently, the external illuminometer 40 (a reference illuminometer) is disposed on the original stage 20. The external illuminometer 40 whose absolute sensitivity is calibrated in advance can be attached and removed to/from the original stage 20.

Then, the control unit 34 controls the original stage 20 to place a light receiving portion of the external illuminometer 40 into the optical path. At the same time, the control unit 34 controls the drive unit 9 to drive the masking blade 18 to set it to a position at which the illumination light covers the light receiving portion of the external illuminometer 40. Subsequently, the control unit 34 irradiates the measurement light from the light source 1 onto the external illuminometer 40 via the illumination optical system.

Thus, the control unit 34 controls the external illuminometer 40 to measure the illuminance on the original surface (a plane on which the original 22 is to be disposed) to measure a third light quantity. The obtained illuminance measurement value is Wm [J/m2/pulse], which denotes the absolute illuminance on the original surface. The illuminance Ww [J/m2/pulse] of the substrate surface (a plane on which the substrate 29 is to be disposed) can be represented by formula (6).

Ww=(T×Wm)/β (6)

where Wm [J/m2/pulse] denotes the illuminance on the original surface, and T and β denote the transmittance and magnification of the projection optical system 23, respectively.

Then, the control unit 34 controls a drive unit (not illustrated) to drive and control the original stage 20 to remove the external illuminometer 40 from the optical path (i.e., to move the external illuminometer 40 to the outside of the illumination area) to directly illuminate the projection optical system 23. The control unit 34 also controls the drive unit 26 to drive and control the substrate stage 24 to place the amount-of-exposure monitor 28 fixed to the substrate stage 24 into the optical path (i.e., to move the amount-of-exposure monitor 28 to the inside of the illumination area).

In this state, the control unit 34 irradiates the light flux from the light source 1 onto the amount-of-exposure monitor 28 via the illumination optical system and the projection optical system 23, and controls the amount-of-exposure monitor 28 to measure the amount of exposure (fourth light quantity measurement).

The control unit 34 obtains an output level C of the amount-of-exposure monitor 28. A coefficient for converting the output value of the amount-of-exposure monitor 28 to an absolute illuminance can be determined based on a relation between C and Ww. Since the irradiation light quantities in the third and fourth light quantity measurement can be detected by the integrated-light quantity monitor 13, the difference between the two irradiation quantities can be corrected.

Based on a relation between the output of the amount-of-exposure monitor 28 and the absolute illuminance determined in this way, and on a relation between the output of the amount-of-exposure monitor 28 and the output of the integrated-light quantity monitor 13 obtained separately, the control unit 34 appropriately determines at least one amount-of-exposure control condition and performs exposure operations.

Thus, a target amount of exposure on the substrate surface is obtained. Amount-of-exposure control conditions may include a target integrated value output by the integrated-light quantity monitor 13, the light emission energy of the light source 1, the oscillating frequency of the light source 1, the light attenuation ratio in the illumination optical system, and the scanning speed of the original stage 20.

As the external illuminometer, a calibrated photodetector (optoelectric conversion elements such as a CCD, a photo-diode, and a photomultiplier, and thermoelectric elements such as a thermocouple and a pyroelectric sensor) can be used. The unit of the amount of measurement (measurement value) of the external illuminometer maybe [W/m2] in addition to [J/m2/pulse] described in the present exemplary embodiment. Alternatively, it is also possible to transfer a substrate having photosensitive agent applied to the original plate position instead of the external illuminometer, perform exposure operations, and then determine the illuminance on the original surface from the exposure sensitivity and change of the photosensitive agent.

As a method for measuring the transmittance, it is possible to use the TTR microscope 33 like the second exemplary embodiment as well as other light quantity detection units. The measured illuminance does not necessarily need to be used to determine amount-of-exposure control conditions, and may be used for maintenance of the exposure apparatus or other purposes. The illumination distribution may be measured through measurement at a plurality of measuring positions in the angle of view of the projection optical system 23. Similar to the first exemplary embodiment, the present exemplary embodiment may measure the illuminance for each individual illumination condition.

According to the fourth exemplary embodiment, it is possible to accurately obtain the illuminance at portions where direct measurement is difficult, from the illuminance at portions where measurement can be performed relatively easily. Particularly with an immersion exposure apparatus, the present exemplary embodiment can obtain the illuminance on the substrate surface under immersion condition (NA>1) by measuring the illuminance on the original surface instead of direct measurement.

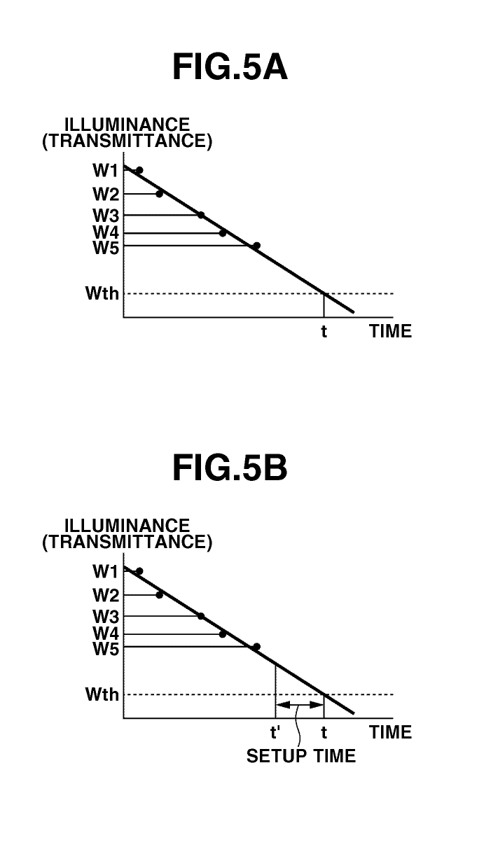

A method for maintaining optical elements according to a fifth exemplary embodiment will be described below with reference to FIGS. 5A and 5B. First, the present exemplary embodiment measures the transmittance of the projection optical system 23, which is an optical system to be measured, by using the methods described in the first to fourth exemplary embodiments, and stores the measurement value in the memory unit 35 as W1. Subsequently, the present exemplary embodiment performs similar measurement at desired time intervals or timing, and stores a plurality of measurement values W2, W3, and so on in the memory unit 35.

Measurement values with elapsed time are illustrated in FIGS. 5A and 5B, where Wth denotes the minimum transmittance necessary to maintain expected performance of the exposure apparatus.

The control unit 34 according to the present exemplary embodiment performs first-order approximation of measurement values W1 to W5 to estimate the tendency of future change in illuminance to predict timing (time) t when the transmittance falls below the threshold value Wth. For example, the alarming unit 36 may display the time t (result of prediction) to allow maintenance personnel to check it constantly or, as shown in FIG. 5B, generate an alarm at time t′ in consideration of a time period necessary to arrange maintenance parts and prepare for maintenance.

As an index for maintenance time prediction, the transmittance distribution may be used other than the transmittance. To estimate future change in transmittance distribution, extrapolation (linear approximation) using two latest measurement values, curve approximation, and fitting to known change tendency may be used.

Since the progress of contamination generally depends on the number of irradiation pulses and irradiation energy of the light source 1, tendency of future change in transmittance can be predicted based on the number of irradiation pulses and irradiation energy in the past.

Thus, the maintenance method according to the fifth exemplary embodiment can predict the tendency of future change in illuminance, and notify appropriate maintenance time in advance, thus shortening maintenance-related non-operating time of the exposure apparatus.

Although the above-mentioned exemplary embodiments have specifically been described based on a case where the original stage is illuminated from the side of the illumination optical system, the original stage may be illuminated from below the second reflecting member disposed on the substrate stage, for example, by leading the light from the light source to the substrate stage.

In this case, a detector may be provided, which detect the second reflected light from the second reflecting member and the light (the first reflected light), which was reflected by the first reflecting member disposed on the original stage and completed a round-trip travel in the projection optical system 23.

A method for manufacturing a device (a semiconductor device or a liquid crystal display device) according to an exemplary embodiment of the present invention will be described below.

A semiconductor device is manufactured through a pre-process and a post-process. The pre-process produces an integrated circuit on a wafer (a semiconductor substrate). The post-process completes as a product the integrated circuit chip on the wafer produced by the pre-process.

The pre-process may include a process for exposing the wafer to which photosensitive agent is applied using the above-mentioned exposure apparatus and a process for developing the wafer exposed in the exposure process. The post-process may include an assembly process (dicing and bonding) and a packaging process (enclosure).

A liquid crystal display device is manufactured through a process for forming transparent electrodes. The process for forming transparent electrodes may include a process for applying photosensitive agent to a glass substrate on which a transparent conducting layer is evaporated, a process for exposing the glass substrate on which photosensitive agent is applied using the above-mentioned exposure apparatus, and a process for developing the glass substrate exposed in the exposure process.

The device manufacturing method according to the present exemplary embodiment is more advantageous than conventional methods in terms of at least one of device productivity, device quality, and device production cost.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-303329 filed Nov. 28, 2008, which is hereby incorporated by reference herein in its entirety.

What is claimed is:

1. An exposure apparatus comprising:
an original stage configured to hold an original;
a substrate stage configured to hold a substrate;
an illumination optical system configured to illuminate the original with light from a light source;
a projection optical system configured to project light from the original illuminated by the illumination optical system to the substrate to expose the substrate to light;
a detector configured to detect first reflected light from a first reflecting member disposed on the original stage and second reflected light from a second reflecting member disposed on the substrate stage produced by illumination with light from the light source, wherein either the first or second reflected light travels forward via the projection optical system and backward via the projection optical system, and is detected by the detector; and
a processor configured to obtain intensities of the first reflected light and the second reflected light based on an output from the detector, and to calculate transmittance of the projection optical system based on the obtained intensities.

2. An apparatus according to claim 1, wherein the detector is configured to detect the first reflected light and the second reflected light produced by illumination from a side of the illumination optical system with respect to the original stage.

3. An apparatus according to claim 1, wherein the detector includes a half mirror disposed on an optical path of the illumination optical system and a light quantity sensor disposed on an optical path split from the optical path of the illumination optical system by the half mirror, and
wherein the processor is configured to control positions of the original stage and the substrate stage to sequentially dispose the first and second reflecting members on an optical path, and to cause the detector to sequentially detect the first reflected light and the second reflected light.

4. An apparatus according to claim 1, wherein the first reflecting member is a first reference mark fixed to the original stage, and the second reflecting member is a second reference mark fixed to the substrate stage.

5. An apparatus according to claim 1, wherein the first reflecting member is a substrate held on the original stage, and the second reflecting member is a substrate held on the substrate stage.

6. An apparatus according to claim 1, wherein the detector includes a TTR microscope configured to illuminate a first reference mark fixed to the original stage and a second reference mark fixed to the substrate stage with light from the light source, and to pick up images of the illuminated first and second reference marks, and
wherein the processor is configured to control positions of the original stage and the substrate stage to dispose the first and second reference marks in an optical path, to cause the TTR microscope to pick up an image of the first and second reference marks, and to obtain intensities of the first reflected light and the second reflected light based on signals of the picked up image.

7. An apparatus according to claim 1, wherein the processor is configured to calculate the transmittance based on each reflectivity of the first and second reflecting members.

8. An apparatus according to claim 1, wherein the processor is configured to calculate the transmittance based on a numeric aperture of the projection optical system.

9. An apparatus according to claim 1, further comprising an illuminance sensor fixed to the substrate stage,
wherein the processor is configured to calibrate an output of the illuminance sensor based on the calculated transmittance, an output of a reference illuminometer disposed on the original stage, and an output of the illuminance sensor.

10. An apparatus according to claim 9, wherein the apparatus is configured to expose the substrate to light via liquid filled in a gap between the final surface of the projection optical system and the substrate.

11. An exposure apparatus comprising:
an original stage configured to hold an original;
a substrate stage configured to hold a substrate;
an illumination optical system configured to illuminate the original with light from a light source;
a projection optical system configured to project light from the original illuminated by the illumination optical system to the substrate to perform an exposure of the substrate to light;
a first reflecting member configured to reflect light at a first position on an optical path of the exposure;
a second reflecting member configured to reflect light at a second position on the optical path, wherein an optical element exists between the first and second positions;
a detector configured to detect first reflected light from the first reflecting member and second reflected light from the second reflecting member, each produced by illumination with light from the light source; and
a processor configured to obtain intensities of the first reflected light and the second reflected light based on an output from the detector, and to calculate a transmittance of the optical element based on the obtained intensities.

12. A method of manufacturing a device, the method comprising:
exposing a substrate to light using an exposure apparatus;
developing the exposed substrate; and
processing the developed substrate to manufacture the device,
wherein the exposure apparatus includes
an original stage configured to hold an original;
a substrate stage configured to hold a substrate;
an illumination optical system configured to illuminate the original with light from a light source;
a projection optical system configured to project light from the original illuminated by the illumination optical system to the substrate to expose the substrate to light;
a detector configured to detect first reflected light from a first reflecting member disposed on the original stage and second reflected light from a second reflecting member disposed on the substrate stage produced by illumination with light from the light source, wherein either the first or second reflected light travels forward via the projection optical system and backward via the projection optical system, and is detected by the detector; and
a processor configured to obtain intensities of the first reflected light and the second reflected light based on an output from the detector, and to calculate transmittance of the projection optical system based on the obtained intensities.

13. A method of manufacturing a device, the method comprising:
exposing a substrate to light using an exposure apparatus;
developing the exposed substrate; and
processing the developed substrate to manufacture the device,
wherein the exposure apparatus includes:
an original stage configured to hold an original;
a substrate stage configured to hold a substrate;
an illumination optical system configured to illuminate the original with light from a light source;
a projection optical system configured to project light from the original illuminated by the illumination optical system to the substrate to perform an exposure of the substrate to light;
a first reflecting member configured to reflect light at a first position on an optical path of the exposure;
a second reflecting member configured to reflect light at a second position on the optical path, wherein an optical element exists between the first and second positions;
a detector configured to detect first reflected light from the first reflecting member and second reflected light from the second reflecting member, each produced by illumination with light from the light source; and
a processor configured to obtain intensities of the first reflected light and the second reflected light based on an output from the detector, and to calculate a transmittance of the optical element based on the obtained intensities.
